(19) United States
(12) Patent Application Publication
(10) Pub. No.: US 2026/0070094 A1
(43) Pub. Date: Mar. 12, 2026

(54) SUBSTRATE PROCESSING APPARATUS

(71) Applicant: SHIBAURA MECHATRONICS CORPORATION, Kanagawa (JP)

(72) Inventors: Kensuke DEMURA, Kanagawa (JP); Satoshi NAKAMURA, Kanagawa (JP); Masashi YAMAGE, Kanagawa (JP)

(21) Appl. No.: 19/321,608

(22) Filed: Sep. 8, 2025

(30) Foreign Application Priority Data
Sep. 9, 2024 (JP) 2024-154985
Aug. 6, 2025 (JP) 2025-131196

(51) Int. Cl. B08B 5/02; B08B 7/00; B08B 13/00

(52) U.S. Cl. CPC B08B 5/02; B08B 7/0092; B08B 13/00

(57) ABSTRACT

According to an embodiment, a substrate processing apparatus includes a mounting unit that includes a mounting table capable of mounting a substrate thereon, and rotates the substrate mounted on the mounting table, a cooling unit that supplies a cooling gas into a space between the mounting table and the substrate through a cooling gas nozzle, and a liquid supply unit that supplies a liquid to a surface of the substrate opposite to a surface of the mounting table. The cooling gas nozzle has at least one first nozzle hole that is inclined in a direction away from a rotational center axis of the substrate as approaching the substrate.

### CROSS-REFERENCE TO RELATED APPLICATIONS

This application is based on and claims priority from Japanese Patent Application Nos. 2024-154985 and 2025-131196, filed on Sep. 9, 2024 and Aug. 6, 2025, respectively, with the Japan Patent Office, the disclosures of which are incorporated herein in their entireties by reference.

### TECHNICAL FIELD

The present disclosure relates to a substrate processing apparatus.

### BACKGROUND

As a method of removing contaminants such as particles attached to the surface of a substrate such as an imprint template, a photolithography mask, or a semiconductor wafer, a freeze cleaning method has been proposed.

In the freeze cleaning method, first, a liquid is supplied to the surface of a rotating substrate. Next, the supply of the liquid is stopped, and some of the supplied liquid is discharged to form a liquid film on the surface of the substrate. The liquid film formed on the surface of the substrate is frozen by a cooling gas supplied to the backside of the substrate. When the liquid film freezes to form a frozen film, contaminants such as particles are incorporated into the frozen film, so that the contaminants are separated from the surface of the substrate. Next, liquid is supplied to the frozen film to melt the frozen film, and the contaminants are removed from the surface of the substrate together with the liquid.

Here, since the vicinity of the peripheral edge of the substrate is close to the external atmosphere not only in the direction perpendicular to the surface of the substrate but also in the direction parallel to the surface of the substrate, the amount of heat input from the outside to the vicinity of the peripheral edge of the substrate increases. Therefore, when a cooling gas is simply supplied to the backside of the substrate, variations in the in-plane temperature of the substrate may occur. When variations in the in-plane temperature of the substrate occur, it becomes difficult to improve the removal rate of contaminants. See, e.g., Japanese Patent Laid-Open Publication No. 2018-026436.

Accordingly, there has been a demand for the development of a substrate processing apparatus capable of suppressing the occurrence of variations in the in-plane-temperature of a substrate.

### SUMMARY

The present disclosure provides a substrate processing apparatus capable of suppressing the occurrence of variations in the in-plane temperature of a substrate.

A substrate processing apparatus according to an embodiment includes: a mounting unit that includes a mounting table capable of mounting a substrate thereon, and rotates the substrate mounted on the mounting table; a cooling unit that supplies a cooling gas into a space between the mounting table and the substrate through a cooling gas nozzle; and a liquid supply unit that supplies a liquid to a surface of the substrate opposite to a surface of the mounting table. The cooling gas nozzle has at least one first nozzle hole that is inclined in a direction away from a rotational center axis of the substrate as approaching the substrate.

According to an embodiment of the present disclosure, there is provided a substrate processing apparatus capable of suppressing the occurrence of variations in the in-plane temperature of a substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic view illustrating a substrate processing apparatus according to an embodiment.

FIG. 2A is a schematic plan view illustrating a cooling gas nozzle as viewed from a direction along a rotational center axis of a substrate, and FIG. 2B is a schematic cross-sectional view illustrating the cooling gas nozzle as viewed from a direction intersecting the rotational center axis of the substrate.

FIG. 3 is a schematic cross-sectional view illustrating a cooling gas nozzle according to another embodiment.

FIG. 4 is a schematic cross-sectional view illustrating a cooling gas nozzle according to yet another embodiment.

FIG. 5 is a schematic cross-sectional view illustrating a cooling gas nozzle according to still yet another embodiment.

FIG. 6 is a timing chart illustrating an operation of the substrate processing apparatus.

FIG. 7 is a schematic cross-sectional view illustrating a cooling gas nozzle according to a comparative example.

FIG. 8 is a graph illustrating effects of the cooling gas nozzle according to the comparative example.

FIG. 9 is a graph illustrating effects of the cooling gas nozzle according to the present embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

Hereinafter, embodiments will be illustrated with reference to the drawings. In the drawings, identical reference numerals are assigned to similar components, and detailed descriptions thereof are omitted as appropriate.

A substrate 100 exemplified below may be, for example, a semiconductor wafer, an imprint template, a photolithography mask, or a plate-shaped body used for a micro electro mechanical system (MEMS).

In this case, the substrate 100 may be a substrate having a surface on which patterned concave and convex portions are formed, or a substrate before the formation of concave and convex portions (e.g., a so-called bulk substrate).

In the following description, as an example, a case in which the substrate 100 is a photolithography mask will be described. When the substrate 100 is a photolithography mask, a planar shape of the substrate 100 may be substantially quadrangular.

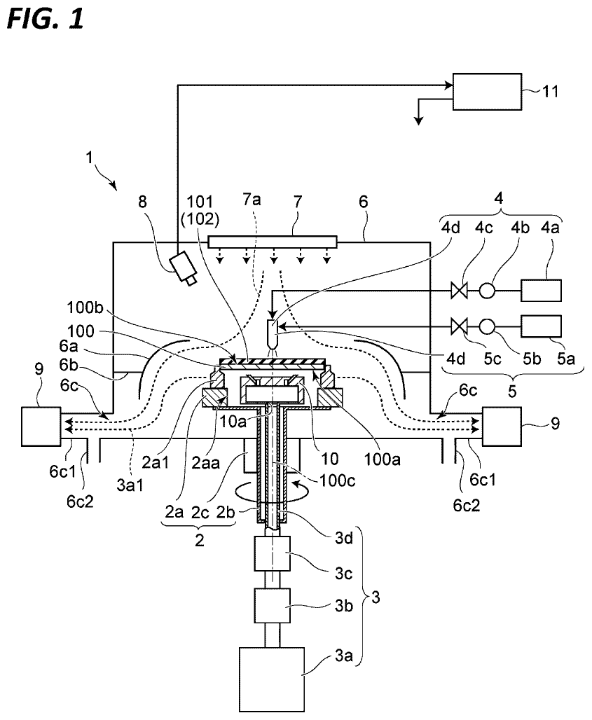

FIG. 1 is a schematic view illustrating a substrate processing apparatus 1 according to an embodiment.

As illustrated in FIG. 1, the substrate processing apparatus 1 includes, for example, a mounting unit 2, a cooling unit 3, a first liquid supply unit 4, a second liquid supply unit 5, a housing 6, a blower unit 7, a detection unit 8, an exhaust unit 9, a cooling gas nozzle 10, and a controller 11.

The mounting unit 2 includes, for example, a mounting table 2a, a rotary shaft 2b, and a driving unit 2c.

The mounting table 2a is rotatably provided inside the housing 6. The mounting table 2a has a plate shape. On one principal surface of the mounting table 2a, a plurality of support portions 2a1 are provided to support the substrate 100. An edge of a rear surface 100a of the substrate 100 comes into contact with the plurality of support portions 2a1. When the substrate 100 is supported by the plurality of support portions 2a1, a front surface 100b of the substrate 100 (a surface to be cleaned) is oriented opposite to the mounting table 2a side.

In addition, a hole 2aa penetrating through a thickness direction of the mounting table 2a is provided at a central portion of the mounting table 2a.

The rotary shaft 2b has a cylindrical shape. One end portion of the rotary shaft 2b is joined to the mounting table 2a. The other end portion of the rotary shaft 2b is provided outside the housing 6. The rotary shaft 2b is connected to the driving unit 2c outside the housing 6.

At the end portion of the rotary shaft 2b opposite to the mounting table 2a side, a cooling gas supply pipe 3d, which will be described later, is attached. Between the end portion of the rotary shaft 2b opposite to the mounting table 2a side and the cooling gas supply pipe 3d, a rotary shaft seal (not illustrated) is provided. Therefore, the end portion of the rotary shaft 2b opposite to the mounting table 2a side is sealed so as to be airtight.

The driving unit 2c is provided outside the housing 6. The driving unit 2c is connected to the rotary shaft 2b. The driving unit 2c may include a rotating machine such as a motor. The rotational force of the driving unit 2c is transmitted to the mounting table 2a via the rotary shaft 2b. Therefore, the driving unit 2c may rotate the mounting table 2a, and consequently, rotate the substrate 100 mounted on the mounting table 2a.

Further, the driving unit 2c may vary not only initiation and termination of rotation but also a rotational speed (e.g., number of rotations). The driving unit 2c may include, for example, a control motor such as a servo motor.

That is, the mounting unit 2 includes the mounting table 2a that may mount the substrate 100 thereon, and the mounted substrate 100 is rotatable.

In this case, a rotational center axis 100c of the substrate 100 mounted on the mounting table 2a may be substantially coaxial with a rotational center axis of the mounting table 2a (e.g., a center axis of the rotary shaft 2b).

The cooling unit 3 supplies a cooling gas 3a1, via the cooling gas nozzle 10 to be described later, to a rear surface 100a of the substrate 100 and to a space between the mounting table 2a and the rear surface 100a of the substrate 100.

The cooling unit 3 includes, for example, a coolant unit 3a, a filter 3b, a flow rate controller 3c, and a cooling gas supply pipe 3d. The coolant unit 3a, the filter 3b, and the flow rate controller 3c are provided outside the housing 6.

The coolant unit 3a stores a coolant and generates the cooling gas 3a1. The coolant is a liquefied form of the cooling gas 3a1. The cooling gas 3a1 is not particularly limited as long as it is a gas that hardly reacts with the material of the substrate 100. For example, the cooling gas 3a1 may be an inert gas such as nitrogen gas, helium gas, or argon gas.

The coolant unit 3a includes a tank that stores the coolant, and a vaporization unit that vaporizes the coolant stored in the tank. The tank is provided with a cooling device that maintains a temperature of the coolant. The vaporization unit raises the temperature of the coolant to generate the cooling gas 3a1 from the coolant. The temperature of the cooling gas 3a1 may be equal to or lower than a freezing point of a liquid 101. The temperature of the cooling gas 3a1 is, for example, about −170° C.

The filter 3b is connected to the coolant unit 3a via a pipe. The filter 3b suppresses contaminants such as particles contained in the coolant from flowing out toward the substrate 100 side.

The flow rate controller 3c is connected to the filter 3b via a pipe. The flow rate controller 3c controls a flow rate of the cooling gas 3a1. The flow rate controller 3c may be, for example, a mass flow controller (MFC). Alternatively, the flow rate controller 3c may control the flow rate of the cooling gas 3a1 indirectly by controlling a supply pressure of the cooling gas 3a1. In this case, the flow rate controller 3c may be, for example, an auto pressure controller (APC).

A temperature of the cooling gas 3a1 generated from the coolant in the coolant unit 3a is substantially a predetermined temperature. Therefore, by controlling the flow rate of the cooling gas 3a1 with the flow rate controller 3c, it may be possible to control a temperature of the substrate 100, and further, a temperature of the liquid 101 on the front surface 100b of the substrate 100. For example, by controlling the flow rate of the cooling gas 3a1 with the flow rate controller 3c, the liquid 101 may be brought into a supercooled state in a supercooling step to be described later.

The cooling gas supply pipe 3d has a cylindrical shape. One end portion of the cooling gas supply pipe 3d is connected to the flow rate controller 3c. At the other end portion of the cooling gas supply pipe 3d (the end portion on a discharge side of the cooling gas 3a1), the cooling gas nozzle 10, which will be described later, is provided. The cooling gas 3a1, of which the flow rate is controlled by the flow rate controller 3c, is supplied to the cooling gas nozzle 10 via the cooling gas supply pipe 3d.

The first liquid supply unit 4 supplies the liquid 101 to the front surface 100b of the substrate 100 (the surface opposite to the mounting table 2a side). In a freezing step (solid-liquid phase), which will be described later, since the liquid 101 changes into a solid and its volume changes, a pressure wave is generated. It is considered that contaminants attached to the front surface 100b of the substrate 100 are separated by the pressure wave. Therefore, the liquid 101 is not particularly limited as long as it hardly reacts with the material of the substrate 100.

When the liquid 101 is a liquid whose volume increases upon freezing, it is also considered that contaminants attached to the surface of the substrate 100 may be separated by utilizing a physical force accompanying the volume increase. Therefore, the liquid 101 is preferably a liquid that hardly reacts with the material of the substrate 100 and increases in volume upon freezing. For example, the liquid 101 may be water (e.g., pure water or ultrapure water) or a liquid mainly containing water. The liquid mainly containing water may be, for example, a mixed solution of water and alcohol, a mixed solution of water and an acidic solution, or a mixed solution of water and an alkaline solution.

The first liquid supply unit 4 includes, for example, a liquid storage unit 4a, a supply unit 4b, a flow rate controller 4c, and a liquid nozzle 4d. The liquid storage unit 4a, the supply unit 4b, and the flow rate controller 4c are provided outside the housing 6.

The liquid storage unit 4a stores the liquid 101. The liquid 101 is stored in the liquid storage unit 4a at a temperature higher than its freezing point. The temperature of the liquid 101 is, for example, room temperature (20° C.).

The supply unit 4b is connected to the liquid storage unit 4a via a pipe. The supply unit 4b supplies the liquid 101 stored in the liquid storage unit 4a toward the liquid nozzle 4d. The supply unit 4b may be, for example, a pump that has a resistance to the liquid 101.

The flow rate controller 4c is connected to the supply unit 4b via a pipe. The flow rate controller 4c controls a flow rate of the liquid 101 supplied by the supply unit 4b. The flow rate controller 4c may be, for example, a flow control valve. In addition, the flow rate controller 4c may also initiate and terminate supply of the liquid 101.

The liquid nozzle 4d is provided inside the housing 6. The liquid nozzle 4d has a cylindrical shape. One end portion of the liquid nozzle 4d is connected to the flow rate controller 4c via a pipe. The other end portion of the liquid nozzle 4d faces the front surface 100b of the substrate 100 mounted on the mounting table 2a. Therefore, the liquid 101 ejected from the liquid nozzle 4d is supplied to the front surface 100b of the substrate 100.

The other end portion of the liquid nozzle 4d (an ejection port of the liquid 101) is, for example, positioned substantially at the center of the front surface 100b of the substrate 100. The liquid 101 ejected from the liquid nozzle 4d spreads from substantially the center of the front surface 100b of the substrate 100, and a liquid film having a substantially uniform thickness is formed on the front surface 100b of the substrate 100. Hereinafter, the film of the liquid 101 formed on the front surface 100b of the substrate 100 will be simply referred to as a liquid film.

The second liquid supply unit 5 supplies a liquid 102 to the front surface 100b of the substrate 100.

The second liquid supply unit 5 includes a liquid storage unit 5a, a supply unit 5b, a flow rate controller 5c, and a liquid nozzle 5d.

The liquid 102 may be used in a thawing step, which will be described later. Therefore, the liquid 102 is not particularly limited as long as it hardly reacts with the material of the substrate 100 and hardly remains on the front surface 100b of the substrate 100 in a drying step, which will be described later. The liquid 102 may be, for example, water (e.g., pure water or ultrapure water) or a mixed solution of water and alcohol.

The liquid storage unit 5a may be similar to the liquid storage unit 4a described above. The supply unit 5b may be similar to the supply unit 4b described above. The flow rate controller 5c may be similar to the flow rate controller 4c described above.

A temperature of the liquid 102 may be higher than the freezing point of the liquid 101. In addition, the temperature of the liquid 102 may be a temperature at which the frozen liquid 101 can be thawed. The temperature of the liquid 102 may be, for example, about room temperature (20° C.).

It may also be possible to use the liquid 101 in the thawing step, which will be described later. When the liquid 101 is used in the thawing step, the second liquid supply unit 5 may be omitted.

In the first liquid supply unit 4 and the second liquid supply unit 5, the liquid nozzle 4d may be shared. In addition, a liquid nozzle for ejecting the liquid 101 and a liquid nozzle for ejecting the liquid 102 may be separately provided.

The housing 6 has a box shape. A cover 6a is provided inside the housing 6. The cover 6a receives the liquid 101 or 102 supplied to the substrate 100 and discharged to the outside of the substrate 100 by rotation of the substrate 100. In addition, a partition plate 6b is provided inside the housing 6. The partition plate 6b is provided between an outer surface of the cover 6a and an inner surface of the housing 6.

An outlet 6c is provided in a side surface of a bottom surface side of the housing 6. Used cooling gas 3a1, air 7a, liquid 101, and liquid 102 are discharged from the outlet 6c to the outside of the housing 6. An exhaust pipe 6c1 and a discharge pipe 6c2 are connected to the outlet 6c. The used cooling gas 3a1 and air 7a are discharged to the outside of the housing 6 via the exhaust pipe 6c1. The used liquid 101 and liquid 102 are discharged to the outside of the housing 6 via the discharge pipe 6c2.

The blower unit 7 is provided, for example, in a ceiling of the housing 6. The blower unit 7 supplies the air 7a (outside air) to a space between the partition plate 6b and the ceiling of the housing 6. Therefore, a pressure of the space between the partition plate 6b and the ceiling of the housing 6 becomes higher than an external pressure. As a result, guiding the air 7a supplied by the blower unit 7 to the outlet 6c is facilitated. In addition, it may be possible to suppress contaminants such as particles from entering the inside of the housing 6 from the outlet 6c.

The detection unit 8 is provided in the space between the partition plate 6b and the ceiling of the housing 6. The detection unit 8 detects a temperature of a liquid film or a frozen film obtained by freezing the liquid film. The detection unit 8 may be, for example, a radiation thermometer, a thermo viewer, a thermocouple, or a resistance thermometer. The detected temperature of the liquid film may be used, for example, to control a supercooled state of the liquid 101 in the supercooling step, which will be described later.

The exhaust unit 9 is connected to the exhaust pipe 6c1. The exhaust unit 9 may be, for example, an exhaust pump such as a blower.

The controller 11 controls operations of respective elements provided in the substrate processing apparatus 1. The controller 11 includes, for example, an arithmetic unit such as a central processing unit (CPU) and a storage unit such as a semiconductor memory. The controller 11 may be, for example, a computer. A control program that controls the operations of the respective elements provided in the substrate processing apparatus 1 may be stored in the storage unit. The arithmetic unit controls the operations of the respective elements provided in the substrate processing apparatus 1 using the control program stored in the storage unit, data input by an operator, and data from the detection unit 8.

Here, when the cooling gas 3a1 is simply supplied to the rear surface 100a of the substrate 100, variations in the in-plane temperature of the substrate 100 may occur. For example, since the vicinity of the peripheral edge of the substrate 100 is close to an external atmosphere not only in a direction perpendicular to the surface of the substrate 100 but also in a direction parallel to the surface of the substrate 100, an amount of heat input from the outside to the vicinity of the peripheral edge of the substrate 100 increases. Therefore, when the cooling gas 3a1 is simply supplied to the rear surface 100a of the substrate 100, cooling in the vicinity of the peripheral edge of the substrate 100 may become insufficient as compared with the vicinity of the center of the substrate 100, and thus, variations in the in-plane temperature of the substrate 100 may occur. When variations in the in-plane temperature of the substrate 100 occur, in a cooling step (supercooling step+freezing step), which will be described later, the separation state of contaminants may become non-uniform across the regions of the substrate 100, and it may become difficult to improve the removal rate of contaminants in the entire region of the substrate 100.

Accordingly, in the substrate processing apparatus 1 according to the present embodiment, the cooling gas nozzle 10 is provided. The cooling gas nozzle 10 is a nozzle having at least one nozzle hole that supplies the cooling gas 3a1 to the surface of the substrate 100 on the mounting table 2a side.

As illustrated in FIG. 1, the cooling gas nozzle 10 is provided at the end portion of the cooling gas supply pipe 3d on the cooling gas 3a1 discharge side. The cooling gas nozzle 10 is provided, for example, inside the hole 2aa of the mounting table 2a. The end portion of the cooling gas nozzle 10 on the substrate 100 side may protrude toward the substrate 100 side beyond the surface of the mounting table 2a on the substrate 100 side, may be flush with the surface of the mounting table 2a on the substrate 100 side, or may be located inside the hole 2aa of the mounting table 2a. In the example illustrated in FIG. 1, the end portion of the cooling gas nozzle 10 on the substrate 100 side protrudes toward the substrate 100 side to be higher than the surface of the mounting table 2a on the substrate 100 side.

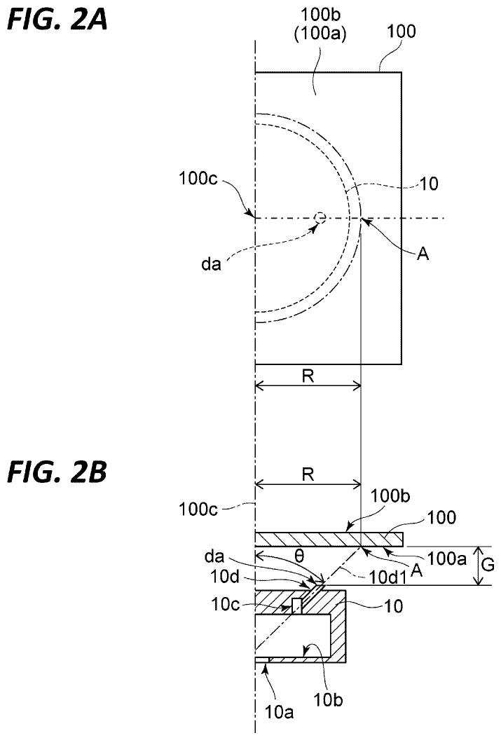

FIG. 2A is a schematic plan view illustrating the cooling gas nozzle 10 as viewed from a direction along the rotational center axis 100c of the substrate 100.

FIG. 2B is a schematic cross-sectional view illustrating the cooling gas nozzle 10 as viewed from a direction intersecting the rotational center axis 100c of the substrate 100.

As illustrated in FIGS. 1, 2A, and 2B, the cooling gas nozzle 10 has, for example, a cylindrical shape whose opposite ends are covered with plate-like members, and includes a supply port 10a, a flow path 10b, a flow path 10c, and a nozzle hole 10d (corresponding to an example of a first nozzle hole). The supply port 10a, the flow path 10b, the flow path 10c, and the nozzle hole 10d are in communication with each other. The nozzle hole 10d serves as a flow passage through which the cooling gas 3a1 is supplied from the cooling gas nozzle 10 to the substrate 100, and is provided to open in a surface (nozzle surface) of the end portion of the cooling gas nozzle 10 on the substrate 100 side. The cooling gas 3a1 is supplied from the supply port 10a into the inside of the cooling gas nozzle 10, and is supplied to the substrate 100 from the nozzle hole 10d via the flow path 10b and the flow path 10c.

The supply port 10a is provided substantially at the center of the cooling gas nozzle 10, and extends along the rotational center axis 100c of the substrate 100. One end portion of the supply port 10a opens in the plate-like member at the end portion of the cooling gas nozzle 10 opposite to the substrate 100 side. The cooling gas supply pipe 3d is connected to one end portion of the supply port 10a. The other end portion of the supply port 10a opens into the flow path 10b.

The flow path 10b is provided inside the cooling gas nozzle 10. The flow path 10b extends, for example, in a direction intersecting the rotational center axis 100c of the substrate 100. The flow path 10b may be, for example, a cylindrical space surrounded by the plate-like members provided at the opposite ends of the cooling gas nozzle 10 and an inner peripheral surface of the cooling gas nozzle 10.

The flow path 10b is, for example, a space having an inner diameter larger than the inner diameter of the cooling gas supply pipe 3d. Thus, the cooling gas nozzle 10 may retain the cooling gas 3a1 supplied through the cooling gas supply pipe 3d in the flow path 10b, and thereafter, supply the cooling gas 3a1 to the rear surface of the substrate 100 from the nozzle hole 10d. As a result, since the cooling gas 3a1 at a pressure stabilized in the space of the flow path 10b may be supplied from the nozzle hole 10d, a stable cooling effect may be obtained. In addition, when a plurality of nozzle holes 10d is provided in the cooling gas nozzle 10, the plurality of nozzle holes 10d may be connected to the single flow path 10b. Thus, by ejecting the cooling gas 3a1 retained in the common flow path 10b from the plurality of nozzle holes 10d, the cooling gas 3a1 may be supplied at substantially the same pressure, and a uniform cooling effect may be obtained within the plane of the substrate 100.

The flow path 10c is provided inside the cooling gas nozzle 10. The flow path 10c extends, for example, along the rotational center axis 100c of the substrate 100. One end portion of the flow path 10c opens into an end portion of the flow path 10b on the substrate 100 side. Near the other end portion of the flow path 10c, an end portion of the nozzle hole 10d opposite to the substrate 100 side is connected. The flow path 10c may have, for example, a columnar shape, and one flow path 10c may be provided for one nozzle hole 10d. When a plurality of nozzle holes 10d are provided, one flow path 10c may be provided for the plurality of nozzle holes 10d. For example, a ring-shaped flow path 10c may be connected to the plurality of nozzle holes 10d.

The flow path 10c is not necessarily required and may be omitted. When the flow path 10c is omitted, the nozzle holes 10d are connected to the flow path 10b.

At least one nozzle hole 10d may be provided. When a plurality of nozzle holes 10d are provided, for example, the plurality of nozzle holes 10d may be provided at different positions in a radial direction with respect to the rotational center axis 100c of the substrate 100 (the rotational center axis of the mounting table 2a). The nozzle hole 10d is connected to the supply port 10a via the flow path 10c and the flow path 10b. As illustrated in FIG. 2B, the nozzle hole 10d is inclined with respect to the rotational center axis 100c of the substrate 100. For example, the nozzle hole 10d is inclined in a direction away from the rotational center axis 100c of the substrate 100 as approaching the substrate 100 side.

In this case, as illustrated in FIGS. 2A and 2B, a distance R (corresponding to an example of a first distance) between a point A (corresponding to an example of a first point) at which an extension line 10d1 of the center axis of the nozzle hole 10d intersects with the rear surface 100a of the substrate 100 and the rotational center axis 100c of the substrate 100 may be made smaller than or the same as a maximum value of a distance (corresponding to an example of a second distance) between the peripheral edge of the substrate 100 and the rotational center axis 100c of the substrate 100.

For example, when the planar shape of the substrate 100 is quadrangular, the distance R may be shorter than or the same as the half of the diagonal length. For example, when the planar shape of the substrate 100 is circular, the distance R may be shorter than or the same as the radius.

In addition, there is a correlation between the distance R and an angle (inclination angle θ) formed between the extension line 10d1 of the center axis of the nozzle hole 10d and the rotational center axis 100c of the substrate 100. For example, the longer the distance R, the larger the inclination angle θ becomes.

The nozzle hole 10d may be, for example, a hole provided in the cooling gas nozzle 10, or a hole of a pipe (cylindrical member) provided in the cooling gas nozzle 10. That is, a pipe may be inserted into a hole formed in the surface (nozzle surface) of the end portion of the cooling gas nozzle 10 on the substrate 100 side, so that the hole of the pipe makes up the nozzle hole 10d. The nozzle hole 10d illustrated in FIG. 2B is the hole of the pipe provided in the cooling gas nozzle 10. An opening da of the nozzle hole 10d on the substrate 100 side may be located flush with the surface (nozzle surface) of the end portion of the cooling gas nozzle 10 on the substrate 100 side. Alternatively, as illustrated in FIG. 2B, the pipe may protrude from the surface (nozzle surface) of the end portion of the cooling gas nozzle 10 on the substrate 100 side, such that the opening da may be located at a position protruding from the surface (nozzle surface) of the end portion of the cooling gas nozzle 10 on the substrate 100 side.

As described above, when the pipe of the cooling gas nozzle 10 protrudes from the surface (nozzle surface) of the end portion on the substrate 100 side, a certain space may be secured between the cooling gas nozzle 10 and the substrate 100, which may prevent the water drops attached to the surface (nozzle surface) of the end portion of the cooling gas nozzle 10 on the substrate 100 side from adhering to and contaminating the rear surface of the substrate 100, while allowing the opening da of the nozzle hole 10d to approach the substrate 100, thereby supplying the cooling gas at a lower temperature.

In addition, when the nozzle hole 10d is formed by processing the nozzle surface of the cooling gas nozzle 10, processing residues generated in the processed portion may mix into the cooling gas 3a1 passing through the nozzle hole 10d, and may adhere to the substrate 100 as particles. In contrast, by inserting a pipe into a hole formed in the nozzle surface and supplying the cooling gas 3a1 through the hole of the pipe serving as the nozzle hole 10d, it may be possible to suppress the processed portion of the nozzle surface from coming into direct contact with the cooling gas 3a1, and reduce the probability that particles generated from the processed portion adhere to the substrate 100 along the flow of the cooling gas 3al.

The cooling gas 3a1 ejected from the nozzle hole 10d is supplied to the rear surface 100a of the substrate 100. In this case, since the nozzle hole 10d is inclined in the direction away from the rotational center axis 100c of the substrate 100 as approaching the substrate 100 side, the cooling gas 3a1 ejected from the nozzle hole 10d mainly flows toward the peripheral edge side of the substrate 100 on the rear surface 100a of the substrate 100. In addition, some of the cooling gas 3a1 colliding with the rear surface 100a of the substrate 100 flows toward the rotational center axis 100c side of the substrate 100 on the rear surface 100a of the substrate 100. In this case, the flow rate of the cooling gas 3a1 flowing toward the peripheral edge side of the substrate 100 is larger than the flow rate of the cooling gas 3a1 flowing toward the rotational center axis 100c side of the substrate 100.

Here, as described above, an amount of heat input into the substrate 100 from the outside is larger in the peripheral edge region of the substrate 100 than in the central region of the substrate 100. Since the cooling gas nozzle 10 according to the present embodiment has the nozzle hole 10d described above, the amount of cooling gas 3a1 supplied to the peripheral edge region of the substrate 100, where the amount of heat input is large, may be made larger than the amount of cooling gas 3a1 supplied to the central region of the substrate 100, where the amount of heat input is small.

Therefore, the occurrence of variations in the in-plane temperature of the substrate 100 may be suppressed. As a result, in the cooling step (supercooling step+freezing step) to be described later, the occurrence of the non-uniform separation state of contaminants across the regions of the substrate 100 may be suppressed, and thus, the removal rate of contaminants in the entire region of the substrate 100 may be improved.

The number, arrangement, and inclination angle θ of the nozzle holes 10d, a diameter of the nozzle holes 10d, and a distance G between the openings of the nozzle holes 10d and the rear surface 100a of the substrate 100 in a direction along the rotational center axis 100c of the substrate 100 may be appropriately changed depending on, for example, a planar dimension of the substrate 100. For example, when the planar dimension of the substrate 100 is large, the number of nozzle holes 10d may be increased or the inclination angle θ may be made larger. In addition, the flow rate of the cooling gas 3a1 may be adjusted by the diameter of each nozzle hole 10d. In addition, by shortening the distance G, the flow rate of the cooling gas 3a1 directly supplied to the rear surface 100a of the substrate 100 may be increased.

For example, experiments or simulations may be performed to appropriately determine the number, arrangement, and inclination angle θ of the nozzle holes 10d, the diameter of each nozzle hole 10d, the distance G, and so on, such that variations in the in-plane temperature of the substrate 100 are reduced.

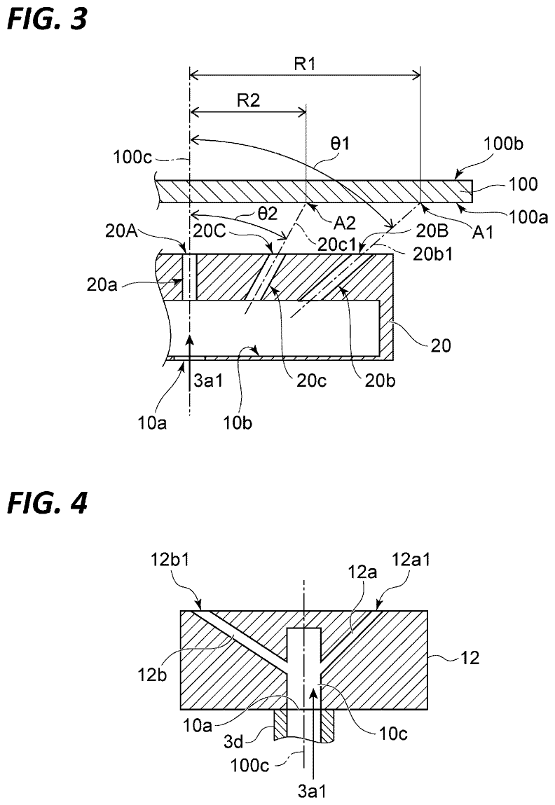

FIG. 3 is a schematic cross-sectional view illustrating a cooling gas nozzle 20 according to another embodiment. As illustrated in FIG. 3, the cooling gas nozzle 20 has, for example, a cylindrical shape whose opposite ends are covered with plate-like members, and includes a supply port 10a, a flow path 10b, a nozzle hole 20a (corresponding to an example of a second nozzle hole), a nozzle hole 20b (corresponding to an example of a first nozzle hole), and a nozzle hole 20c (corresponding to an example of a first nozzle hole). In the cooling gas nozzle 20, the flow path 10c described above is omitted. The nozzle holes 20a, 20b, and 20c are directly provided in the flow path 10b.

For example, the nozzle hole 20a supplies the cooling gas 3a1 to the vicinity of the center of the rear surface 100a of the substrate 100. The nozzle hole 20a extends, for example, along the rotational center axis 100c of the substrate 100.

For example, the nozzle hole 20b supplies the cooling gas 3a1 to the vicinity of the peripheral edge of the rear surface 100a of the substrate 100. For example, the nozzle hole 20c supplies the cooling gas 3a1 to a region between the vicinity of the center and the vicinity of the peripheral edge of the rear surface 100a of the substrate 100. In addition, the nozzle hole 20c and the nozzle hole 20b are inclined like the nozzle hole 10d described above, in a direction away from the rotational center axis 100c of the substrate 100 as approaching the substrate 100 side.

The diameter of an opening 20A of the nozzle hole 20a may be smaller than the diameters of openings 20B and 20C of the nozzle holes 20b and 20c. In this way, since the flow rate of the cooling gas 3a1 directly supplied to a central region of the rear surface 100a of the substrate 100 may be smaller than that to a peripheral edge region of the substrate 100, which receives a large amount of heat input from the outside and is difficult to cool, local cooling of the central region may be suppressed, and variations in the in-plane temperature of a liquid film formed on the front surface 100b of the substrate 100 may be reduced. In addition, the diameter of the opening 20B may be larger than the diameter of the opening 20C. As a result, the flow rate of the cooling gas 3a1 supplied to the peripheral edge region, which is difficult to cool, may be increased, and variations in the in-plane temperature of the liquid film formed on the front surface 100b of the substrate 100 may be further reduced.

In addition, a distance R1 (corresponding to an example of a first distance) between a point A1 (corresponding to an example of a first point) at which an extension line 20b1 of a center axis of the nozzle hole 20b intersects with the rear surface 100a of the substrate 100 and the rotational center axis 100c of the substrate 100 is longer than a distance R2 (corresponding to an example of a first distance) between a point A2 (corresponding to an example of a first point) at which an extension line 20c1 of a center axis of the nozzle hole 20c intersects with the rear surface 100a of the substrate 100 and the rotational center axis 100c of the substrate 100. In addition, an inclination angle θ1 of the nozzle hole 20b is larger than an inclination angle θ2 of the nozzle hole 20c.

Furthermore, at least one of each of the nozzle holes 20a, 20b, and 20c may be provided. In this case, the number of nozzle holes 20b may be the same as or greater than the number of nozzle holes 20c. The number of nozzle holes 20c may be the same as or greater than the number of nozzle holes 20a.

As described above, when a plurality of nozzle holes are provided in which a distance (distance R) between a point at which an extension line of a central axis of each nozzle hole intersects with the rear surface 100a of the substrate 100 and the rotational center axis 100c of the substrate 100 is different, by setting the arrangement of the plurality of nozzle holes such that a relationship between conductance of the nozzle holes and a processing area satisfies the following, variations in the in-plane temperature of the substrate 100 may be reduced.

Here, the conductance refers to a reciprocal of resistance generated when a gas flows through a specific region, and in this specification, means an ease of flow of the gas through the nozzle hole.

When a plurality of nozzle holes having the same distance R are provided, these nozzle holes are referred to as a “group of nozzle holes having the same distance.” In contrast, a plurality of nozzle holes having different distances R with respect to the above group are referred to as a “group of nozzle holes having different distances.”

The processing area refers to an area of the rear surface 100a of the substrate 100, which is cooled by a flow of the cooling gas supplied from the cooling gas nozzle 10, coming into contact with the rear surface of the substrate, and then flowing outward.

First, “C” is defined as a ratio of conductance of the group of nozzle holes having the same distance, which is a sum of conductances of all nozzle holes having the same distance R (corresponding to an example of a conductance of a first nozzle hole group), to a sum of conductances of all nozzle holes provided in the cooling gas nozzle 20.

For example, in the cooling gas nozzle 20 illustrated in FIG. 3, it is assumed that a plurality of nozzle holes 20b having the same distance R and a plurality of nozzle holes 20c having the same distance R are provided. In this case, a ratio of conductance of the plurality of nozzle holes 20b to the sum of conductances of all the nozzle holes is defined as “C1.” Similarly, a ratio of conductance of the plurality of nozzle holes 20c to the sum of conductances of all the nozzle holes is defined as “C2.”

When conductance of the nozzle hole 20a is c0, a sum of conductances of the plurality of nozzle holes 20b is c1, and a sum of conductances of the plurality of nozzle holes 20c is c2, “C1=c1/(c0+c1+c2)” and “C2=c2/(c0+c1+c2)” may be obtained.

Next, a ratio “S” is defined as a ratio of a processing area of a group of nozzle holes having the same distance R to a sum of processing areas of all nozzle holes provided in the cooling gas nozzle 20.

The “processing area of the group of nozzle holes having the same distance R” is obtained from a difference between an area of the rear surface 100a and an area of a virtual circle having a radius corresponding to the distance R.

For example, in the cooling gas nozzle 20 illustrated in FIG. 3, a ratio of processing areas of the plurality of nozzle holes 20b to a sum of processing areas of all the nozzle holes is defined as “S1,” and a ratio of processing areas of the plurality of nozzle holes 20c to a sum of processing areas of all the nozzle holes is defined as “S2.”

When a processing area of the nozzle hole 20a is s0, a processing area of the plurality of nozzle holes 20b is s1, and a processing area of the plurality of nozzle holes 20c is s2, “S1=s1/(s0+s1+s2)” and “S2=s2/(s0+s1+s2)” may be obtained. Since the distance R of the nozzle hole 20a is zero, s0 may be the same as the area of the rear surface 100a.

Then, it may be possible to set the distance between the point at which the extension line of the center axis of the nozzle hole intersects with the rear surface 100a of the substrate 100 and the rotational center axis 100c of the substrate 100 such that a difference between a maximum value and a minimum value of a value obtained by “V=C/S” becomes 3 or less.

For example, in the case of the cooling gas nozzle 20 illustrated in FIG. 3, the distances R1 and R2 may be set such that a difference between “V1=C1/S1” and “V2=C2/S2” becomes 3 or less.

In this way, the temperature of the substrate 100 in a region between the point A1 and the peripheral edge of the substrate 100 and the temperature of the substrate 100 in a region between the point A2 and the point A1 may have a small difference. That is, variations in the in-plane temperature of the substrate 100 may be reduced.

In freeze cleaning, cleaning power (removal rate of contaminants) is improved by repeating freezing and thawing. When the number of contaminants before a cleaning process is NI, and the number of contaminants after the cleaning process is NP, the removal rate of contaminants (PRE) may be expressed by the following equation:

PRE(%)=((NI−NP)/NI)×100

When variations in the in-plane temperature of the substrate 100 become large, variations in the cleaning power within the plane of the substrate per freezing cycle also become large. As a result, it becomes necessary to increase the number of freezing cycles, which deteriorates throughput. Therefore, it is desirable to reduce the variations in the in-plane temperature of the substrate 100 and to reduce variations in the in-plane cleaning power per freezing cycle.

As described above, by reducing variations in “V” to 3 or less, it may be possible to suppress variations in the cleaning power to less than 20%.

In addition, conductance ca of a nozzle hole used in the equation for calculating “V” may be obtained by the following equation when the length of the nozzle hole along the center axis is La and the cross-sectional area of the nozzle hole is sa:

ca=(6.28×10⁸)×sa²/La

By using the conductance thus obtained, variations in the in-plane temperature of the substrate 100 may be reduced.

It is also preferable to reduce a difference between a maximum value and a minimum value of a ratio of the sum of conductances of all groups of nozzle holes having different distances R relative to a distance R. For example, the maximum value may be set to four times or less the minimum value.

In this way, variations in the in-plane temperature of the substrate 100 may be further reduced.

FIG. 4 is a schematic cross-sectional view illustrating a cooling gas nozzle 12 according to yet another embodiment.

As illustrated in FIG. 4, in the cooling gas nozzle 12, the flow path 10b is omitted, and the center axis of the flow path 10c coincides with the rotational center axis 100c. This point is different from the cooling gas nozzles of the embodiments illustrated in FIGS. 1 and 3.

As illustrated in FIG. 4, the cooling gas nozzle 12 has, for example, a cylindrical shape, and includes a supply port 10a, a flow path 10c, a nozzle hole 12a, and a nozzle hole 12b. The supply port 10a, the flow path 10c, and the nozzle hole 12a are in communication with each other. The supply port 10a, the flow path 10c, and the nozzle hole 12b are also in communication with each other.

The diameter of the flow path 10c is substantially the same as the diameter of the cooling gas supply pipe 3d. The flow path 10c is connected to the supply port 10a.

The nozzle holes 12a and 12b are provided inside the cooling gas nozzle 12 and intersect with the flow path 10c. The nozzle holes 12a and 12b are inclined in a direction away from the rotational center axis 100c of the substrate 100 as approaching the substrate 100 side. One end portion of each of the nozzle holes 12a and 12b is connected to the flow path 10c. The other end portions of the nozzle holes 12a and 12b open as openings 12a1 and 12b1, respectively, in a surface (nozzle surface) of the end portion of the cooling gas nozzle 12 on the substrate 100 side.

The cooling gas 3a1 is supplied from the supply port 10a connected to the cooling gas supply pipe 3d into the inside of the cooling gas nozzle 12, and is supplied to the substrate 100 from the nozzle holes 12a and 12b via the flow path 10c.

The opening 12b1 of the nozzle hole 12b may be provided at a position different from the opening 12a1 of the nozzle hole 12a. For example, when viewed in a direction perpendicular to the front surface 100b of the substrate 100, the distance between the rotational center axis 100c and the opening 12b1 of the nozzle hole 12b is different from the distance between the rotational center axis 100c and the opening 12a1 of the nozzle hole 12a.

The flow path 10c has a space above the positions where the inclined nozzle holes 12a and 12b are connected thereto. Thus, the cooling gas nozzle 12 may retain the cooling gas 3a1 supplied through the cooling gas supply pipe 3d in the flow path 10c, and supply the cooling gas 3a1 to the rear surface of the substrate 100 from the nozzle holes 12a and 12b. As a result, since the cooling gas 3a1 at a pressure stabilized in the space of the flow path 10c may be supplied from the nozzle holes 12a and 12b, a stable cooling effect may be obtained. In addition, by connecting a plurality of nozzle holes to one flow path 10c, the cooling gas 3a1 retained in the common flow path 10c may be ejected from the plurality of nozzle holes. As a result, the cooling gas 3a1 may be supplied from each of the plurality of nozzle holes at substantially the same pressure. Accordingly, a uniform in-plane cooling effect may be obtained in the substrate 100.

As in the case of the nozzle hole 10d described above, a pipe (e.g., a cylindrical member) may be inserted into a hole provided in the surface (e.g., a nozzle surface) of the end portion of the cooling gas nozzle 12 on the substrate 100 side, so that the hole of the pipe makes up the nozzle holes 12a and 12b.

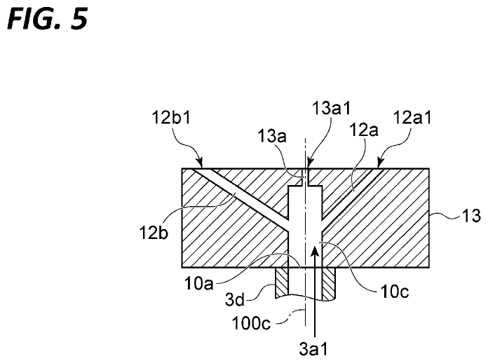

FIG. 5 is a schematic cross-sectional view illustrating a cooling gas nozzle 13 according to still yet another embodiment.

As illustrated in FIG. 5, the cooling gas nozzle 13 includes, for example, a supply port 10a, a flow path 10c, a nozzle hole 12a, and a nozzle hole 13a. In the cooling gas nozzle 13 illustrated in FIG. 5, the nozzle hole 13a is provided at the end portion of the flow path 10c on the substrate 100 side. This point is different from the cooling gas nozzle 12 illustrated in FIG. 4.

The supply port 10a, the flow path 10c, and the nozzle hole 13a are in communication with each other.

The nozzle hole 13a is provided inside the cooling gas nozzle 13 and extends along the rotational center axis 100c of the substrate 100. One end portion of the nozzle hole 13a is in communication with the flow path 10c, and the other end portion of the nozzle hole 13a opens at the end portion of the cooling gas nozzle 13 on the substrate 100 side.

The cooling gas 3a1 is supplied from the supply port 10a connected to the cooling gas supply pipe 3d into the inside of the cooling gas nozzle 13, and is supplied to the substrate 100 from the nozzle holes 12a, 12b, and 13a via the flow path 10c.

An opening 13a1 of the nozzle hole 13a faces, for example, the center of the rear surface 100a of the substrate 100.

In this way, the cooling gas 3a1 may also be directly supplied to a central region of the rear surface 100a of the substrate 100. Therefore, even when a planar dimension of the substrate 100 is large, cooling the entire rear surface 100a of the substrate 100 substantially uniformly is facilitated.

As illustrated in FIG. 5, the diameter of the opening 13a1 of the nozzle hole 13a may be smaller than diameters of the openings 12a1 and 12b1 of the nozzle holes 12a and 12b. In this way, the flow rate of the cooling gas 3a1 directly supplied to a central region of the rear surface 100a of the substrate 100 may be smaller than that directly supplied to a peripheral edge region of the rear surface 100a of the substrate 100, which receives a large amount of heat input from the outside. Therefore, by suppressing the local cooling of the central region of the rear surface 100a of the substrate 100, variations in the in-plane temperature of the liquid film formed on the front surface 100b of the substrate 100 may be reduced.

In addition, the center of the opening 13a1 of the nozzle hole 13a may be located at a position deviated from the rotational center axis 100c of the substrate 100.

When the opening 13a1 is disposed at a position overlapping the rotational center axis 100c, the same portion (central portion) of the substrate 100 always faces the opening 13a1 even when the substrate 100 rotates. Accordingly, the central region of the rear surface 100a of the substrate 100 may be locally cooled easily.

In contrast, when the opening 13a1 is located at a position deviated from the rotational center axis 100c of the substrate 100, a portion of the rear surface 100a of the substrate 100 that faces the opening 13a1 sequentially moves as the substrate 100 rotates. Accordingly, the central portion in the vicinity of the rotational center axis 100c and a surrounding portion thereof may be cooled more uniformly.

As in the case of the nozzle hole 10d described above, a pipe (cylindrical member) may be inserted into a hole provided in the surface (nozzle surface) of the end portion of the cooling gas nozzle 13 on the substrate 100 side, so that the hole of the pipe makes up the nozzle hole 13a.

Next, an operation of the substrate processing apparatus 1 will be exemplified.

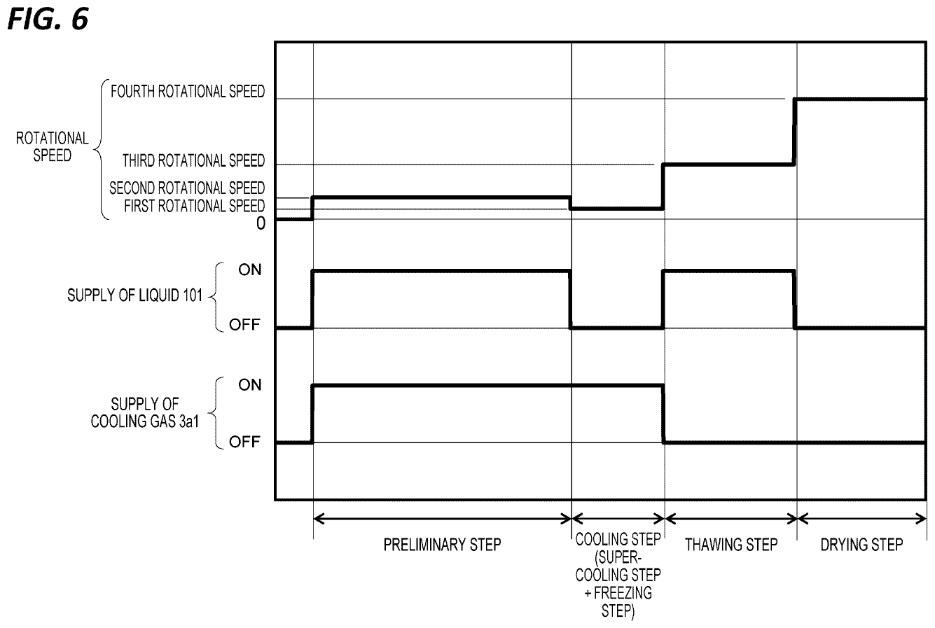

FIG. 6 is a timing chart illustrating the operation of the substrate processing apparatus 1.

FIG. 6 illustrates a case where the substrate 100 is a 6025 quartz (Qz) substrate (152 mm×152 mm×6.35 mm), and the liquid 101 is pure water.

First, the substrate 100 is carried into the inside of the housing 6 through a carry-in/carry-out port (not illustrated). The carried-in substrate 100 is placed on and supported by the plurality of support portions 2a1 of the mounting table 2a.

After the substrate 100 is supported on the mounting table 2a, as illustrated in FIG. 6, a freeze cleaning process including a preliminary step, a cooling step (supercooling step+freezing step), a thawing step, and a drying step is performed.

In the preliminary step, the controller 11 controls the supply unit 4b and the flow rate controller 4c to supply the liquid 101 at a predetermined flow rate onto the front surface 100b of the substrate 100. In addition, the controller 11 controls the flow rate controller 3c to supply the cooling gas 3a1 at a predetermined flow rate to the rear surface 100a of the substrate 100. The controller 11 also controls the driving unit 2c to rotate the substrate 100 at a second rotational speed.

For example, the second rotational speed is about 50 rpm to 500 rpm. For example, the flow rate of the liquid 101 is about 0.1 L/min to 1 L/min. For example, the flow rate of the cooling gas 3a1 is about 40 NL/min to 200 NL/min.

Since the liquid 101 is continuously flowing in the preliminary step, the temperature of the liquid film is substantially the same as the temperature of the supplied liquid 101. For example, when the temperature of the supplied liquid 101 is about room temperature (20° C.), the temperature of the liquid film is also about room temperature (20° C.).

Next, as illustrated in FIG. 6, the cooling step (supercooling step+freezing step) is executed. In the present embodiment, in the cooling step, a step from when the liquid 101 becomes supercooled until freezing starts is referred to as a “supercooling step,” and a step from when the supercooled liquid 101 becomes frozen until thawing starts by the thawing step is referred to as a “freezing step.”

Here, when the cooling rate of the liquid 101 becomes overly fast, the liquid 101 does not become supercooled and freezes immediately. Therefore, the controller 11 controls at least one of the flow rate of the cooling gas 3a1 and the rotational speed of the substrate 100 to cause the liquid 101 on the front surface 100b of the substrate 100 to be in a supercooled state.

In addition, as described above, the nozzle holes 10d, 20c, and 20b are inclined in a direction away from the rotational center axis 100c of the substrate 100 as approaching the substrate 100 side. Therefore, since variations in the in-plane temperature of the substrate 100 are reduced, the entire liquid 101 on the front surface 100b of the substrate 100 may be brought into the supercooled state.

In the cooling step (e.g., supercooling step+freezing step), as illustrated in FIG. 6, after the substrate 100 is rotated at a first rotational speed, the supply of the liquid 101 supplied in the preliminary step is stopped. For example, the first rotational speed is about 0 rpm to 50 rpm. That is, the controller 11 rotates the substrate 100 at a lower rotational speed than the rotational speed in the preliminary step.

In the cooling step (e.g., supercooling step+freezing step), by stopping the supply of the liquid 101 and reducing the rotational speed of the substrate 100 to the first rotational speed lower than the second rotational speed, the liquid 101 present on the substrate 100 becomes stagnant. Accordingly, since the cooling gas 3a1 continues to be supplied to the rear surface 100a of the substrate 100, the temperature of the liquid film on the substrate 100 is further reduced compared to the temperature of the liquid film in the preliminary step, and the liquid 101 enters the supercooled state.

The conditions under which the liquid 101 enters the supercooled state are affected by factors such as the size of the substrate 100, the viscosity of the liquid 101, and the specific heat of the cooling gas 3a1. Therefore, it is preferable that control conditions for bringing the liquid 101 to the supercooled state be appropriately determined by performing experiments or simulations.

In the supercooled state, freezing of the liquid 101 starts due to, for example, the temperature of the liquid film, the presence of contaminants such as particles or bubbles, or vibration.

When freezing of the supercooled liquid 101 starts, the process transitions from the supercooling step to the freezing step. In an initial stage of the freezing step, both the liquid 101 and frozen liquid 101 exist on the front surface 100b of the substrate 100.

Subsequently, the liquid 101 is completely frozen, forming a frozen film. After the frozen film is formed, the temperature of the frozen film on the substrate 100 is further reduced by the cooling gas 3a1 that continues to be supplied to the rear surface 100a of the substrate 100.

In this case, as described above, the nozzle holes 10d, 20c, and 20b are inclined in a direction away from the rotational center axis 100c of the substrate 100 as approaching the substrate 100 side. Therefore, since variations in the in-plane temperature of the substrate 100 are reduced, the entire liquid film on the substrate 100 may be frozen to form the frozen film.

Next, as illustrated in FIG. 6, the thawing step is executed. FIG. 6 illustrates a case where the liquid 101 and the liquid 102 are the same liquid. Accordingly, in FIG. 6, the liquid 101 is supplied in the thawing step. In the thawing step, the controller 11 controls the supply unit 4b and the flow rate controller 4c to supply the liquid 101 at a predetermined flow rate to the front surface 100b of the substrate 100. When the liquids 101 and 102 are different, the controller 11 controls the supply unit 5b and the flow rate controller 5c to supply the liquid 102 at a predetermined flow rate to the front surface 100b of the substrate 100.

In addition, the controller 11 controls the flow rate controller 3c to stop the supply of the cooling gas 3a1. The controller 11 further controls the driving unit 2c to increase the rotational speed of the substrate 100 to a third rotational speed. The third rotational speed is, for example, about 200 rpm to 700 rpm. As the rotational speed of the substrate 100 increases, the liquid 101 and the frozen liquid 101 may be spun off by centrifugal force. Accordingly, the liquid 101 and the frozen liquid 101 may be discharged from the front surface 100b of the substrate 100. At this time, contaminants separated from the front surface 100b of the substrate 100 are also discharged together with the liquid 101 and the frozen liquid 101.

In this case, since the nozzle holes 10d, 20c, and 20b are inclined, the frozen film is formed on the entire surface of the substrate 100, so that contaminants may be efficiently separated from the entire surface of the substrate 100. Thus, the removal efficiency of contaminants on the entire surface of the substrate 100 may be improved.

Next, as illustrated in FIG. 6, the drying step is executed. In the drying step, the controller 11 controls the supply unit 4b and the flow rate controller 4c to stop the supply of the liquid 101. When the liquids 101 and 102 are different, the controller 11 controls the supply unit 5b and the flow rate controller 5c to stop the supply of the liquid 102.

In addition, the controller 11 controls the driving unit 2c to increase the rotational speed of the substrate 100 to a fourth rotational speed faster than the third rotational speed. As the rotational speed of the substrate 100 increases, drying of the substrate 100 may be performed quickly. The fourth rotational speed of the substrate 100 is not particularly limited as long as drying can be achieved.

The substrate 100 that has undergone the freeze cleaning is carried out of the housing 6 through the carry-in/carry-out port (not illustrated) of the housing 6.

In this way, the freeze cleaning (removal of contaminants) of the substrate 100 may be performed.

Next, the effects of the inclined nozzle holes will be further described.

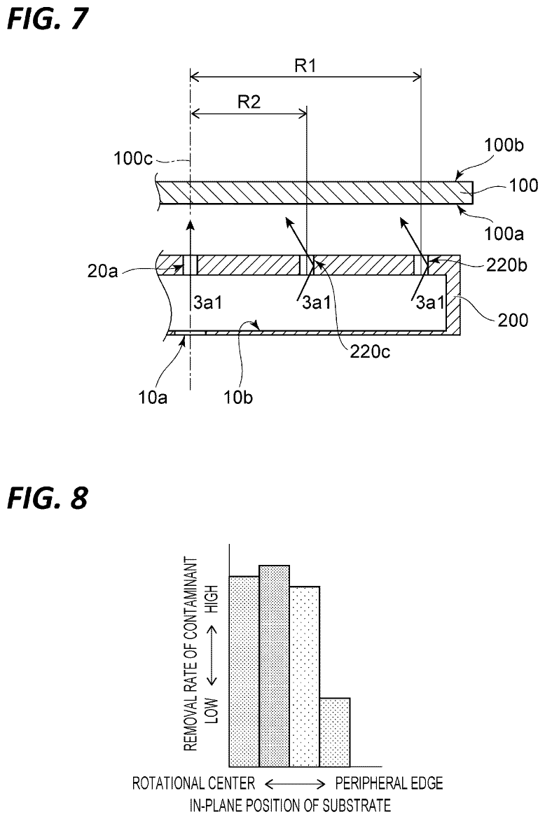

FIG. 7 is a schematic cross-sectional view illustrating a cooling gas nozzle 200 according to a comparative example.

As illustrated in FIG. 7, the cooling gas nozzle 200 has, for example, a plate shape, and includes a supply port 10a, a flow path 10b, a nozzle hole 20a, a nozzle hole 220b, and a nozzle hole 220c. The nozzle hole 20a supplies the cooling gas 3a1 to the vicinity of the center of the rear surface 100a of the substrate 100. The nozzle hole 220b supplies the cooling gas 3a1 to the vicinity of the peripheral edge of the rear surface 100a of the substrate 100. The nozzle hole 220b supplies the cooling gas 3a1 toward a position at a distance R1 from the rotational center axis 100c of the substrate 100. The nozzle hole 220c supplies the cooling gas 3a1 to a region between the vicinity of the center and the vicinity of the peripheral edge of the rear surface 100a of the substrate 100. The nozzle hole 220c supplies the cooling gas 3a1 toward a position at a distance R2 from the rotational center axis 100c of the substrate 100.

The nozzle hole 220b and the nozzle hole 220c are not inclined but extend along the rotational center axis 100c of the substrate 100, similar to the nozzle hole 20a.

When the nozzle hole 20a, the nozzle hole 220b, and the nozzle hole 220c are provided, the cooling gas 3a1 may be supplied to predetermined positions of the rear surface 100a of the substrate 100. However, since the cooling gas 3a1 is mainly supplied in a direction perpendicular to the rear surface 100a of the substrate 100, it may not be possible to increase the amount of the cooling gas 3a1 flowing toward the vicinity of the peripheral edge of the substrate 100, where the amount of heat input is large.

Furthermore, as illustrated in FIG. 7, in the vicinity of the openings of the nozzle hole 20a, the nozzle hole 220b, and the nozzle hole 220c extending along the rotational center axis 100c of the substrate 100, the cooling gas 3a1 colliding with the inner walls of the nozzle holes is ejected in a direction intersecting with the center axes of the nozzle hole 20a, the nozzle hole 220b, and the nozzle hole 220c. Therefore, since the cooling gas 3a1 is dispersed, it may become difficult to control the cooling gas 3a1 to flow toward the vicinity of the peripheral edge of the substrate 100.

Thus, when the plurality of nozzle holes 20a, 220b, and 220c extending along the rotational center axis 100c of the substrate 100 are provided, the cooling gas 3a1 may be supplied to a wide region of the rear surface 100a of the substrate 100, but it may not be possible to make the amount of the cooling gas 3a1 supplied to the peripheral edge region of the substrate 100, where the amount of heat input is large, larger than the amount of the cooling gas 3a1 supplied to the central region of the substrate 100, where the amount of heat input is small. As a result, variations in the in-plane temperature of the substrate 100 tend to occur, and the removal rate of contaminants in the plane of the substrate 100 may become non-uniform. For example, it may become difficult to improve the removal rate of contaminants in the peripheral edge region of the substrate 100.

FIG. 8 is a graph illustrating effects of the cooling gas nozzle 200 according to the comparative example.

As described above, when the plurality of nozzle holes 20a, 220b, and 220c extending along the rotational center axis 100c of the substrate 100 are provided, it may not be possible to increase the amount of the cooling gas 3a1 supplied to the peripheral edge region of the substrate 100, where the amount of heat input is large. Accordingly, the temperature in the peripheral edge region of the substrate 100 tends to become higher than the temperature in the central region of the substrate 100.

As a result, as illustrated in FIG. 8, the removal rate of contaminants in the peripheral edge region of the substrate 100 becomes lower than the removal rate of contaminants in the central region of the substrate 100.

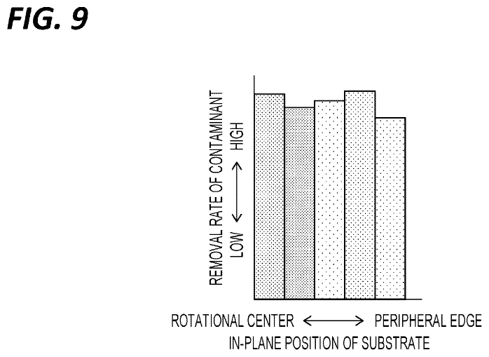

FIG. 9 is a graph illustrating effects of the cooling gas nozzle 20 according to the present embodiment.

As described above, the nozzle hole 20c and the nozzle hole 20b are inclined in a direction away from the rotational center axis 100c of the substrate 100 as approaching the substrate 100 side. Accordingly, the cooling gas 3a1 may be supplied to a wide region of the rear surface 100a of the substrate 100, and the amount of the cooling gas 3a1 supplied to the peripheral edge region of the substrate 100, where the amount of heat input is large, may be increased. Therefore, variations in the in-plane temperature of the substrate 100 are reduced. As a result, as illustrated in FIG. 9, the removal rate of contaminants on the entire rear surface 100a of the substrate 100 may be improved.

For example, shapes, dimensions, numbers, and arrangements of respective elements included in the substrate processing apparatus 1 are not limited to those exemplified, but may be appropriately modified.

From the foregoing, it will be appreciated that various embodiments of the present disclosure have been described herein for purposes of illustration, and that various Modifications may be made without departing from the scope and spirit of the present disclosure. Accordingly, the various embodiments disclosed herein are not intended to be limiting, with the true scope and spirit being indicated by the following claims.

What is claimed is:

1. A substrate processing apparatus comprising:
a mounting stage including a mounting table capable of mounting a substrate thereon, and configured to rotate the substrate mounted on the mounting table;
a cooler configured to supply a cooling gas into a space between the mounting table and the substrate through a cooling gas nozzle; and
a liquid supply configured to supply a liquid to a surface of the substrate opposite to a side of the mounting table,
wherein the cooling gas nozzle has at least one first nozzle hole that is inclined in a direction away from a rotational center axis of the substrate as approaching the substrate.

2. The substrate processing apparatus according to claim 1, wherein a first distance between a first point, at which an extension line of a center axis of the first nozzle hole intersects with a surface of the substrate on the side of the mounting table, and the rotational center axis of the substrate, is equal to or shorter than a maximum value of a second distance between a peripheral edge of the substrate and the rotational center axis of the substrate.

3. The substrate processing apparatus according to claim 2, wherein a plurality of the first nozzle holes having different first distances are provided, and
wherein a first nozzle hole having a longer first distance has, compared to a first nozzle hole having a shorter first distance, a larger angle between the extension line of the center axis of the first nozzle hole and the rotational center axis of the substrate.

4. The substrate processing apparatus according to claim 2, wherein a plurality of the first nozzle holes having different first distances and a plurality of the first nozzle holes having a same first distance are provided, and
assuming that C is defined as a ratio of conductance of a first nozzle hole group, which is a sum of conductances of all the first nozzle holes having the same first distance, to a sum of conductances of all the first nozzle holes in the cooling gas nozzle, and
that S is defined as a ratio of a processing area of the first nozzle hole group, which is a difference between an area of the surface of the substrate on the side of the mounting table and an area of a circle having a radius corresponding to the first distance, relative to a sum of processing areas of all the first nozzle holes, a difference between a maximum value and a minimum value of a value obtained by C/S is 3 or less.

5. The substrate processing apparatus according to claim 4, wherein conductance ca of the first nozzle hole satisfies equation below when a length of the first nozzle hole along the center axis is La, and a cross-sectional area of the first nozzle hole is sa:
ca=(6.28×10⁸)×sa²/La.

6. The substrate processing apparatus according to claim 1, wherein the cooler supplies the cooling gas to the cooling gas nozzle via a cooling gas supply pipe,
the cooling gas nozzle has, inside thereof, a space having an inner diameter larger than an inner diameter of the cooling gas supply pipe, and
the cooling gas is supplied from the cooling gas supply pipe through the space inside the cooling gas nozzle and the first nozzle hole.

7. The substrate processing apparatus according to claim 1, further comprising:
a second nozzle hole extending along the rotational center axis,
wherein a diameter of an opening of the second nozzle hole is smaller than a diameter of an opening of the first nozzle hole inclined in the direction away from the rotational center axis as approaching the substrate.

8. The substrate processing apparatus according to claim 1, wherein the first nozzle hole is a hole of a pipe inserted into a hole provided in the cooling gas nozzle.

9. The substrate processing apparatus according to claim 8, wherein an opening of the hole of the pipe protrudes from a surface of an end portion of the cooling gas nozzle on a side of the substrate.

10. The substrate processing apparatus according to claim 1, wherein the cooling gas nozzle includes, inside thereof, a flow path extending along the rotational center axis of the substrate, and
the first nozzle hole inclined in the direction away from the rotational center axis as approaching the substrate is connected to the flow path, and the flow path has a space above a position where the first nozzle hole is connected.
